(19) United States
(12) Patent Application Publication
(10) Pub. No.: US 2010/0284762 A1
(43) Pub. Date: Nov. 11, 2010

(54) Self-drilling fastening element

(75) Inventors: Kolja Wieczorek, Landsberg (DE); Astrid Buder, Kaufering (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/799,903

(22) Filed: May 3, 2010

(30) Foreign Application Priority Data
May 8, 2009 (DE) 10 2009 002 951.6

(51) Int. Cl. F16B 1/00; C09J 11/00

(52) U.S. Cl. 411/82.3

(57) ABSTRACT

A self-drilling, chemically anchorable fastening element includes a hollow cylindrical receiving body (12) in which an ejectable, hardenable multi-component mass (26) is located and which includes a hardener (27) and a two-formulation reactive resin (28) hardenable in a mixed, with each other, condition, with the formulations (29, 30) being arranged one after another in the receiving body and with the second formulation (30), which hardens rapidly in a mixed condition with the hardener (27), being located, in a setting direction (S) of the fastening element (11), behind a first formulation (29) of the reactive resin (28) which hardens slower in a mixed condition with the hardener.

### BACKGROUND OF THE INVENTION

1. Field of the Invention

The present invention relates to a self-drilling fastening element, in particular, to a self-drilling rock anchor to be chemically anchored in a constructional component such as, e.g., a rock or a constructional part, formed of a mineral material such as concrete or masonry.

2. Description of the Prior Art

Fastening elements of the type described above, e.g., a rock anchor, serve for stabilization of hollow spaces such as tunnels, galleries, and the like and, namely, for attaching walls of adjacent rock regions to each other.

In many cases, it is proceeded from the premise that the regions in the immediate vicinity of the walls have, as a result of formation of hollow spaces, reduced mechanical characteristics, in particular, a reduced load carrying capacity than further, remotely located, non-damaged rock regions, and should be attached to the remotely located regions. Under the term “walls of a hollow space” is understood, in this connection, in addition to ceiling sections and side walls of hollow spaces, also their bottom regions. Further, such fastening elements can be used as links for transmission of large loads.

With a chemically anchorable fastening element according to U.S. Pat. No. 4,303,354, two tubular film bags with hardenable masses, which harden with different speeds, are placed in a preliminary formed borehole, with the tubular bag located adjacent to the borehole bottom, containing a rapidly hardenable composition and with tubular bag adjoining the previous tubular bag, containing a relatively slower hardenable mass. Upon setting of a fastening element, firstly, the tubular bag, which contains the slow hardenable mass is destructed, and the components contained therein form a first mixture of the hardenable mass. Then, the tubular bag, which contains the rapidly hardenable mass, is destructed, and the components contained therein form a second mixture of the hardenable mass, with the second mixture starting to harden right away.

The drawback of the known solution consists in that firstly, a borehole should be formed with a separate tool, and the insertion of two tubular bags in each borehole is expensive. In addition, inadvertently, the tubular bags can be inserted in a borehole in incorrect order, so that upon setting of the fastening element, firstly, the tubular bag with a rapidly hardenable composition is destructed. As a result, a correct setting of the fastening element is not possible any more or possible only to a limited extent.

U.S. Pat. No. 4,055,051 discloses a self-drilling fastening element of the type disclosed above and which is provided with an ejectable mass at its power tool side and can easily be set. The fastening element has a hollow cylindrical body at one end of which a drilling head is provided and in which an ejectable, hardenable multi-component mass is provided. The hardenable mass includes a hardener and a reactive resin, which is kept separate, and which hardens in a mixed condition. In the drilling head, there are provided through-openings for the hardenable mass.

The fastening element according to U.S. Pat. No. 4,055,051 is drilled into a constructional component. After a desired setting depth is reached, the hardenable mass, which is stored in a film container, is ejected under pressure, with a mixture being formed upon passing through the openings in the drilling head, and filling the space surrounding the fastening element. After hardening of the hardenable mass, the fastening element is chemically anchored in the constructional component.

The drawback of the fastening element of U.S. Pat. No. 4,055,051 consists in that the fastening elements cannot be loaded until the hardenable mass hardens.

Accordingly, an object of the present invention is to provide a chemically anchorable fastening that can be easily and reliably set and that can be rapidly loaded up to a predetermined level.

### SUMMARY OF THE INVENTION

This and other objects of the present invention, which will become apparent hereinafter, are achieved by providing a fastening element of the type discussed above and in which at least the reactive resin has two different formulation arranged, in the receiving body, one after another, and the second formulation of the reactive resin, which hardens rapidly in a mixed condition with the hardener, is located, in a setting direction of the fastening element behind a first formulation of the reactive resin which hardens slower in a mixed condition with the hardener.

After a complete ejection of the components of the hardenable mass, there are available two hardenable mixtures of the hardenable mass having different hardening speeds. The firstly pouring-out first mixture hardens with slower speed and insures a subsequent pouring-out of the second mixture. The second mixture, which pours out after the first mixture, hardens more rapidly than the first mixture and, advantageously, right away. Thereby, it is insured that the fastening element is anchored in the constructional component more rapidly and reliably. The rapidly hardenable mixture is located in the region of the borehole bottom, which insures an advantageous introduction or transfer of force in the constructional component.

According to another embodiment, the reactive resin can include more than two formulation arranged one after another. In this case, the first pouring-out mixture of the hardenable mass has a hardening speed that is slower than a hardening speed of the second pouring-out mixture, and mixture that follows the second mixture, has a more rapid hardening speed than the second pouring-out mixture.

Advantageously, the hardenable mass is provided at the power tool side of the fastening element provided with the drilling head. Thereby, a reliable use of the fastening element on the site is insured.

For a complete intermixing of the components of the hardenable mass, advantageously, a mixing element is provided between the components of the hardenable mass and at the at least one through-opening in the region of the drilling head. Alternatively, or in addition, the through-openings in the drilling head are so formed that upon passing of the components through, they are intermixed in appropriate amounts to form a corresponding mixture.

The fastening element can be used as an active anchor, i.e., as a pre-stressable anchor, and as a passive anchor, i.e., as a non-pre-stressable anchor.

With an active anchor, a fastening element that has already been partially anchored in the constructional component by the rapidly hardenable mixture, is pre-stressed with a pre-stressing element. The time-delayed post-hardening of the slow or moderately hardened first mixture in the pre-stress region chemically secures the pre-stress of the fastening element obtained during its pre-stressing.

With a passive anchor, the drilling tool and the ejection unit can be removed immediately after a complete ejection of the components of the hardenable mass and used for setting another fastening element because at least partial anchoring of the fastening element is achieved immediately after completion of the ejection of the hardenable mass.

The setting costs of both active anchor and passive anchor is noticeably reduced in comparison with known embodiments of chemically anchorable fastening elements. Further, the fastening element according to the present invention, due to different hardening speeds of the mixture, can be set independent from the temperature of the constructional component. This permits a flexible use of the inventive self-drilling fastening element, in particular, in tunnel or gallery construction. Normally, with cold constructional components, more rapidly hardenable masses are used, and with hot or warm constructional components, slower hardenable masses are used. The inventive fastening element has both types of the hardenable masses, which insures a reliable anchoring of the fastening element in different constructional components.

As a hardener for the resins hardenable, advantageously, as a result of a radical reaction, peroxide compounds, in particular, dibenzoylperoxide, are used. Advantageously, the same hardener is used for both a rapidly hardenable mixture and for a slow hardenable mixture.

The reactive resin is composed of general-purpose rubber, reactive thinner and hardening accelerator. Reactive resins for use in hardenable mass for chemical anchoring of fastening elements are disclosed, e.g., in German Publication DE 42 31 161 or U.S. Pat. No. 4,518,283. However, according to the present invention, the time of hardening of corresponding mixtures is adjusted by varying the ratios of these components to each other, e.g., in a formulation of the reactive resin. Different hardening times or hardening speeds of both formulations of the reactive resin are mostly determined by the amount of the hardening accelerator. Here, first of all, amines are considered, such as N,N-substituted aniline (e.g., N,N dimethylaniline) or N,N-substituted para-toluidine (e.g., N,N dimethyl paratoluidin), but also Co—, Mn—, Sn—, or Ce— salts such as, e.g., cobaltoctoat are considered. Further, advantageously, both formulations include further additives such as, e.g., quartz, glass or hollow glass balls, corundus, chock, talk.

The mixing ratio of the reactive resin having the first formulation and the hardener and the mixing ratio of the reactive resin having the second formulation and hardener advantageously are the same and are in a range 1:1 to 10:1, preferably, 3:1 to 5:1.

Advantageously, the components of the hardenable mass are located in chambers of a tubular bag that is easily produced as a package and, in addition, can be easily arranged in the hollow cylindrical receiving body. Advantageously, the tubular bag is formed as a film bag and further advantageously, is formed of a multi-layer foil adapted to chemical characteristics of the components of the hardenable mass.

Advantageously, all of the components of the hardenable mass are located in a common tubular film bag, which enables a simple manufacturing of the inventive self-drilling fastening element. The tubular foil bag is preferably formed of a flat material which is folded to form a necessary number of chambers and correspondingly welded.

Advantageously, the different formulations of the reactive resin are located in a through-chamber of the tubular film bag extending in a longitudinal direction of the tubular film bag. With this arrangement of the components, the tubular film bag has an advantageously small cross-section and can be easily produced. To exclude an undesirable reaction of the formulations with each other during a storage condition of the fastening element, advantageously, a separation wall is provided between the formulations in the corresponding chamber of the tubular film bag. The separation wall preferably, is easily openable or can be destructed, e.g., under pressure.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a longitudinal cross-sectional view of a self-drilling fastening element according to the present invention in the form of a rock anchor; and

FIG. 2 a longitudinal cross-sectional view of the inventive self-drilling fastening element in a set condition.

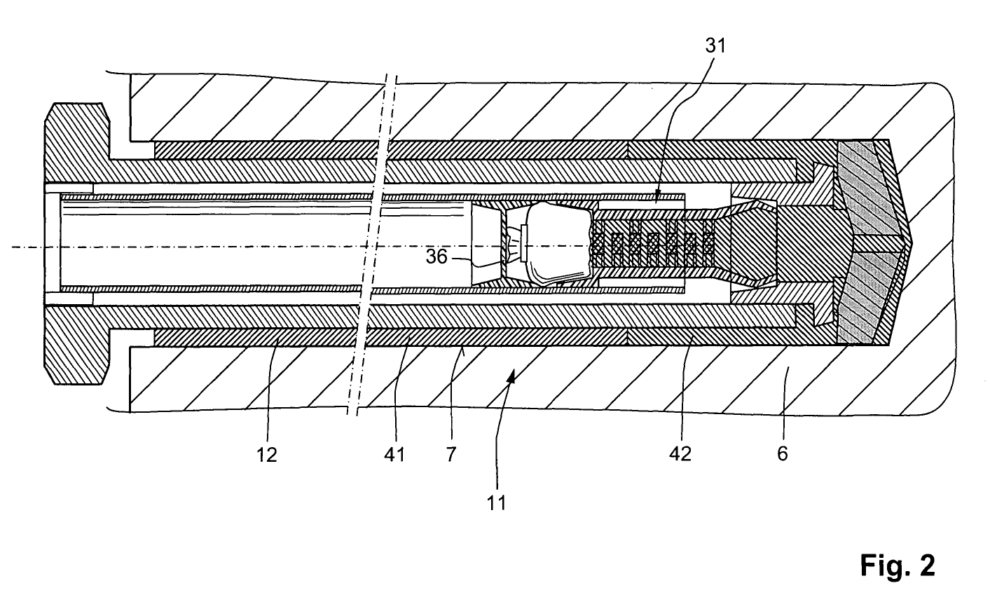

Basically, in the drawings the same elements are provided with the same reference numerals.

### DETAILED DESCRIPTION OF THE PREFERRED EMBODIMENT

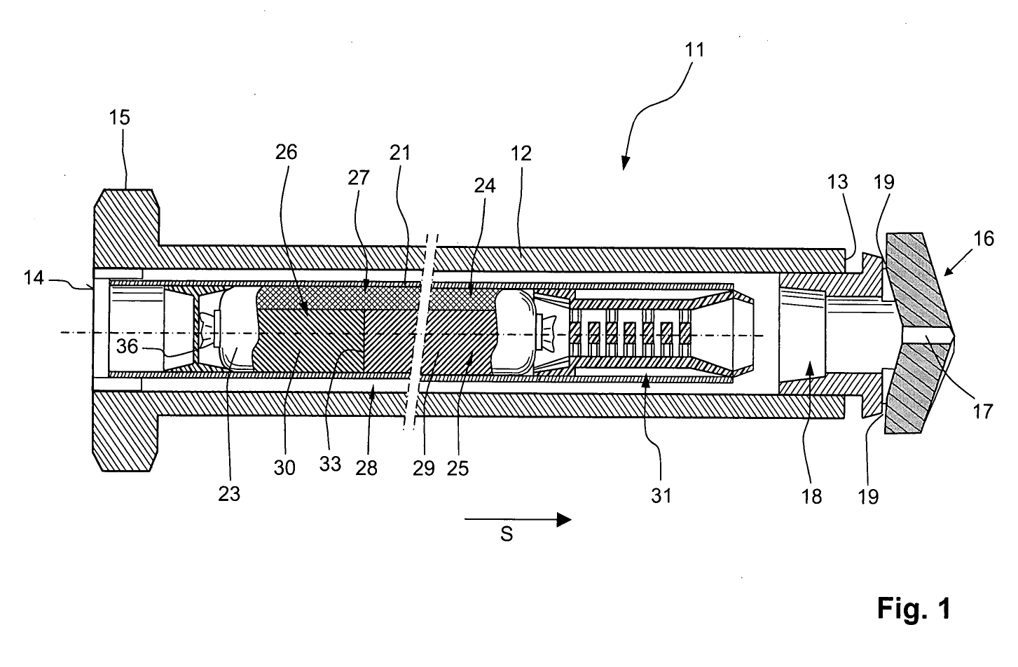

A self-drilling fastening element 11, which is shown in FIG. 1 and is formed as a rock anchor, has a hollow cylindrical receiving body 12 provided, at its end 13 facing in a setting direction S, with a drilling head 16 and, at its opposite end 14, with rotation transmitting means 15, e.g., in form of a polygon connectable with a drilling tool, not shown. The drilling head 16 has a first through-opening 17 and two, opening radially outwardly, second openings 19. There is further provided, in the drilling head 16, a funnel-shaped receptacle 18 narrowing toward the free end of the drilling head 16.

An inner tube 21 is arranged in the receiving body 12. A film container in form of a tubular film bag 23, which is packed with an ejectable, hardenable, multi-component mass, is located in the inner tube 21. The multi-component mass 26 includes a reactive resin 28 and a hardener 27 which are kept separated from one another and which harden in a mixed condition. The hardener 27 is located in a first chamber 24 of the tubular bag 23 extending in the longitudinal direction of the tubular bag 23. The reactive resin 28 is located in a second chamber 25 extending parallel to the first chamber 24 and includes a first formulation 29 and a different, distinguishing, e.g., from the first formulation 29, second formulation 30. The first formulation 29 and a second formulation 30 are arranged one after another in the through-chamber 25 extending in the longitudinal direction of the tubular bag 23. To exclude an undesirable reaction between the first formulation 29 and the second formulation 30 in a non-operational condition of the fastening element 11, a separation wall 33, which is easily openable, e.g., destructed under pressure, is provided between the first formulation 29 and the second formulation 30. The second formulation 30 of the reactive resin 28, which hardens rapidly in a mixed condition with the hardener 27 is located, with reference to the setting direction S of the fastening element 11, behind the first formulation 29 of the reactive resin 28 which hardens slower in the mixed condition with the hardener 27 than the second formulation 30.

Below, for clarification of the invention, there are provided examples of composition of the first formulation of the reactive resin 28, the second formulation 30 of the reactive resin 28, and of the hardener 27. These examples are not exclusive.

Hardener 27:

| | |
|---|---|
| Dibenzoylperoxide | 20.0% by weight |
| Water | 30.0% by weight |
| Quartz .01 to .03 mm | 50.0% by weight |

first formulation 29 of the reactive resin 28 which in a mixed condition with the hardener 27, forms a slow hardenable mixture 41

| | |
|---|---|
| unsaturated polyester resin | 27.0% by weight |
| styrol | 18.0% by weight |
| dimethylaniline | .1% by weight |
| chock | 52.9% by weight |
| fumed silica | 2.0% by weight |

second formulation 30 of the reactive resin 28 which in a mixed condition with the hardener 27, forms a rapidly hardenable mixture 42.

| | |
|---|---|
| bisphenol-A-diglycidyl-dimethacrylate | 25.0% by weight |
| B.1.4 butandiol-dimethylacrylate | 20.0% by weight |
| dimethylaniline | 1.0% by weight |
| chock | 51.5% by weight |
| fumed silica | 2.5% by weight |

The mixing ratio of the first formulation 29 with the hardener 27 and the mixing ratio of the second formulation 30 with the hardener 27 amounts to 3 parts to 1 part (3:1).

In the inner tube 21, between the hardenable mass 26 and the drilling head 16, there is provided a mixing element 31 displaceably arranged in the inner tube 21 and formed, preferably, of a plastic material. At an end of the inner tube 21 opposite the mixing element 31, there is provided an ejection piston 36 for ejecting the hardenable mass 26. The intermediate space between the inner tube 21 and the receiving body 12 insures aspiration of drillings, e.g., drilling dust or feeding rinsing water to the drilling head 16.

The fastening element 11, which is shown in FIG. 1, as a unit is drilled in a constructional component 6 with a drilling/ejection assembly, not shown, connectable with the rotation transmitting means 15 of the receiving body 12.

After a predetermined depth of the bore is reached, the ejection unit applies pressure to the ejection piston 36, e.g., with water used as a pressure application means. As a result, firstly, the mixing element 31 is displaced in the direction of the drilling head 16 until the free end of the mixing element 31 is located in the receptacle 18 of the drilling head 16. Upon a further application of pressure by the ejection piston 36, the ejectable mass 26 flows through the openings 17 and 19 in the drilling head 16 out of the fastening element 11 in a mixed condition.

The first, slow hardenable mixture 41 flows from the fastening element 11 first and fills the intermediate space between the outer wall of the receiving body 12 and the bore wall from the bore bottom up. The next flowing out second mixture 42, which hardens rapidly, forces the first mixture 41 further in the direction of the second end 14 of the receiving body 12. Because of the rapidly hardenable second mixture 42, the fastening element 11 becomes anchored in the region of bore bottom and at least restricted, e.g., for being pre-stressed after the ejection of the hardenable mass 26, so it can be loaded. After a time-delayed hardening of the first mixture 41, the fastening element is completely anchored in the constructional component 6.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A self-drilling fastening element (11) for being chemically anchored in a constructional component (6), comprising a hollow cylindrical receiving body (12); a drilling head (16) provided at one end (13) of the receiving body (12); and an ejectable, hardenable multi-component mass (26) located in the receiving body (12) and including at least one hardener (27) and at least one reactive resin (28) both stored in a condition in which they are separated from each other, and hardenable in a mixed, with each other, condition, the drilling head (16) having at least one through-opening (17, 19) for the hardenable mass (26),
wherein at least the reactive resin (27) has two different formulations (29, 30) arranged, in the receiving body (12) one after another, and
wherein a second formulation (30) of the reactive resin (28), which hardens rapidly in a mixed condition with the hardener (27), is located in a setting direction (S) of the fastening element (11), behind a first formulation (29) of the reactive resin (28) which hardens slower in a mixed condition with the hardener (27).

2. A fastening element according to claim 1, wherein components of the hardenable mass (26) are located in chambers (24, 25) of a tubular film bag (23).

3. A fastening element according to claim 2, wherein all components of the hardenable mass (26) are located in the common tubular bag (23).

4. A fastening element according to claim 2, wherein the two different formulations (29, 30) of the reactive resin (28) are located in a through-chamber (25) of the tubular film bag (23) extending in a longitudinal direction of the tubular film bag (23).
